(19) United States
(12) Patent Application Publication
(10) Pub. No.: US 2025/0244970 A1
(43) Pub. Date: Jul. 31, 2025

(54) USING GENERATIVE AI TO AUTHOR DATA PROTECTION MODULES TAILORED FOR DIFFERENT AS-A-SERVICE APPLICATIONS AND SERVICES

(71) Applicant: HYCU, Inc., Boston, MA (US)

(72) Inventors: Subbiah Sundaram, Boston, MA (US); Mladen Brajkovic, Ljubljana (SI)

(21) Appl. No.: 19/041,288

(22) Filed: Jan. 30, 2025

Related U.S. Application Data
(60) Provisional application No. 63/626,592, filed on Jan. 30, 2024.

(51) Int. Cl. G06F 8/35

(52) U.S. Cl. CPC G06F 8/35

(57) ABSTRACT

Code for augmenting functions of a SaaS application is generated by informed, iterative prompting of a generative artificial intelligence (genAI) tools. The code may include an automatically generated data model for the SaaS and at least one resource of the SaaS. The genAI tool is further prompted to produce code that initiates the functions for one or more instances of the SaaS within a data processing environment. The resource, for example, includes a recovery capability of the SaaS and the data model includes one or more markers indicating attributes of the data model such as which portions are natively recoverable by the SaaS. An LLM for the genAI leverages a Retrieval Augmented Generation (RAG) model that represents domain-specific knowledge of the SaaS application and the data processing environment.

### CROSS-REFERENCE TO RELATED APPLICATIONS

This patent application claims priority to a co-pending U.S. Provisional Application 63/626,592 filed Jan. 30, 2024 entitled “Using Generative AI to Author Data Protection Modules Tailored for Different as-a-Service Applications and Services”

This patent application also relates to several other pending U.S. patent applications filed by the same applicant, including:

DISCOVERY OF SERVICES ENABLING DATA PROTECTION AND OTHER WORKFLOWS Ser. No. 18/426,535 filed Jan. 30, 2024; and

R-GRAPH PROPAGATION OF DATA PROTECTION AND COMPLIANCE STATUSES, Ser. No. 18/426,614 filed Jan. 30, 2024; and

API MODEL FOR AS-A-SERVICE DATA RESILIENCE MANAGEMENT Ser. No. 18/426,638 filed Jan. 30, 2024.

Each of the above referenced patent applications is hereby incorporated by reference.

### BACKGROUND

This patent application relates to managing cloud services, and in particular to leveraging generative artificial intelligence (genAI) and automation tools to author code modules that manage and/or augment functions or attributes of such services.

Cloud Services (e.g., Saas (software as a service), PaaS (Platform as a Service), DBaaS (Database as a Service, IaaS (Infrastructure as a Service), etc.) have become an integral part of many business computing environments. The advantages of cloud services are well known and include the ability to scale to meet demand as requested, and to only pay for what is needed. It is also expensive and time-consuming to maintain any software application on a regular basis. However, with as-a-Service deployments, the service provider becomes responsible for the maintenance and performance of the service, freeing an enterprises' own staff from complex software and hardware management responsibilities.

As the management of data processing functions has moved from an enterprises' own staff to the cloud service, the risk of losing critical functions has increased. Risks can include things such as human error, data mismanagement such as adopting weak processes for acquiring, validating, storing, protecting, and processing data, or weak data security resulting in complexities to protecting data from unwanted actions such as a cyber-attack or a data breach.

Many cloud services have mechanisms to protect data as part of keeping the service up and running, but customer dependent data needs are left up to the customer to manage. Considering there are an estimated 35,000 different SaaS applications and thousands of other native services built by public cloud vendors to deliver Infrastructure as a Service, Platform as a Service and Database as a Service. There is no way that any one data protection provider can offer data resilience for all such services and potential customer data configurations in a timely manner.

### SUMMARY OF THE INVENTION

In example embodiments, a modular platform architecture called R-Cloud (as described in the above-referenced patent applications) can be used to control generation of a workflow to be executed within or on behalf of a SaaS application, such as a data resilience workflow. R-Cloud abstracts core data resilience related management functions for a cloud service or SaaS into a code module called an R-Cloud plug-in. The approach is a modular architecture where adding data resilience functions for a new service simply requires the creation of a new plug-in. The new plug-in can be dynamically added to the running service and the R-Cloud system can then start delivering the data resilience plug-ins associated with each service and each instantiation of a service. By way of example, the plug-ins can record the service's unique authentication methods, sets of attributes, data structures, data resilience attributes, and other behaviors.

However, creating these modules is still a time-consuming task. To reduce the effort needed and to provide greater scale of deployment, according to the teachings here, Artificial Intelligence (AI) automation tools are employed to author R-Cloud plug-ins. A “brute force” application of Generative AI will not work well for complete protection of a service. That is because every service has its own unique authentication methods, set of attributes, data structures, specifications as to what can be backed up and what is recoverable, unique licensing models, and other behavior. In addition, the generate modules need to operate with the right set of API hooks, understand the R-Cloud platform requirements, understand the optimizations allowed by the R-Cloud platform, etc. So the modules have to be built by a tool that has cross platform knowledge and understands the associated integration methodology.

This enriched AI model-driven process provides an inherent understanding of the complexities and nuances of SaaS data protection, including compliance standards, encryption methodologies, and recovery protocols specific to the R-Cloud architecture.

The result is a significant reduction in development time-from weeks to hours-for creating data protection integrations. This not only accelerates the deployment process but also ensures that each integration adheres to the high standards of security and efficiency.

More generally, preferred embodiments herein relate to a method and or system for augmenting functions of a SaaS application accessible to a data processing environment. An example workflow involves
(a) obtaining information regarding the SaaS application, including at least an identity, an access method and documentation;
(b) prompting one or more generative artificial intelligence (genAI) tools with the information to produce code for authentication and authorization for the Saas;
(c) prompting the one or more genAI tools to produce code for generating a data model for the SaaS and detect at least one resource of the SaaS; and
(d) for one or more instances of the SaaS within the data processing environment, prompting the genAI tool to produce code that initiates the function for the one or more instances.

The developer may review, modify or approve the code that was auto-generated in any of these steps of the workflow.

In some implementations, the resource includes a native recovery capability of the SaaS and the function is data backup. In that instance the data model may include one or more markers indicating which portions of the data model are recoverable by the SaaS. The markers may also indicate a last time of backup.

The genAI may be further prompted to produce documentation or test procedures for the generated code; and the code generated may be provided as a structured code delivery.

If the genAI is based on one or more Large Language Models (LLMs), the LLMs may be augmented with Retrieval Augmented Generation (RAG) models that represent domain-specific knowledge of the SaaS application and the data processing environment.

In one particular arrangement, the function is automatic data protection for the SaaS, and the data model relates to data objects arranged at one or more levels of a hierarchy within the SaaS. In that instance, step (d) of the workflow generates code for discovering data objects accessed by the SaaS, identifying a service resource for protecting the data object, discovering attributes specific to the data objects, including a data protection attribute that indicates whether a data protection method is accessible to protect the data objects via the service resource at one or more levels of a hierarchy, obtaining information for use with another data protection method that is other than via the service resource, and executing a granular data protection process, by accessing the data protection attribute information for each data object.

### BRIEF DESCRIPTION OF THE DRAWINGS

FIG. 1 is an example data processing environment where a generative AI automation tool is employed to author a cloud service management module.

FIG. 2 is an example of a data catalog maintained by R-Cloud.

FIG. 3 is a workflow for automated authoring of the cloud service module.

### DETAILED DESCRIPTION OF PREFERRED EMBODIMENTS

In the example embodiment described in detail below, an automated code authoring process creates a plug-in module that discovers data configuration(s) utilized by a cloud data service and generates appropriate data resilience methods. The approach enables protection and recovery of the data in the service and associated configurations with minimal complexity. However, it should be understood that the same general approach can be applied in a structured way for (a) other types of services (e.g., SaaS, PaaS, DBaaS, IaaS) and (b) to manage other aspects and attributes of such services.

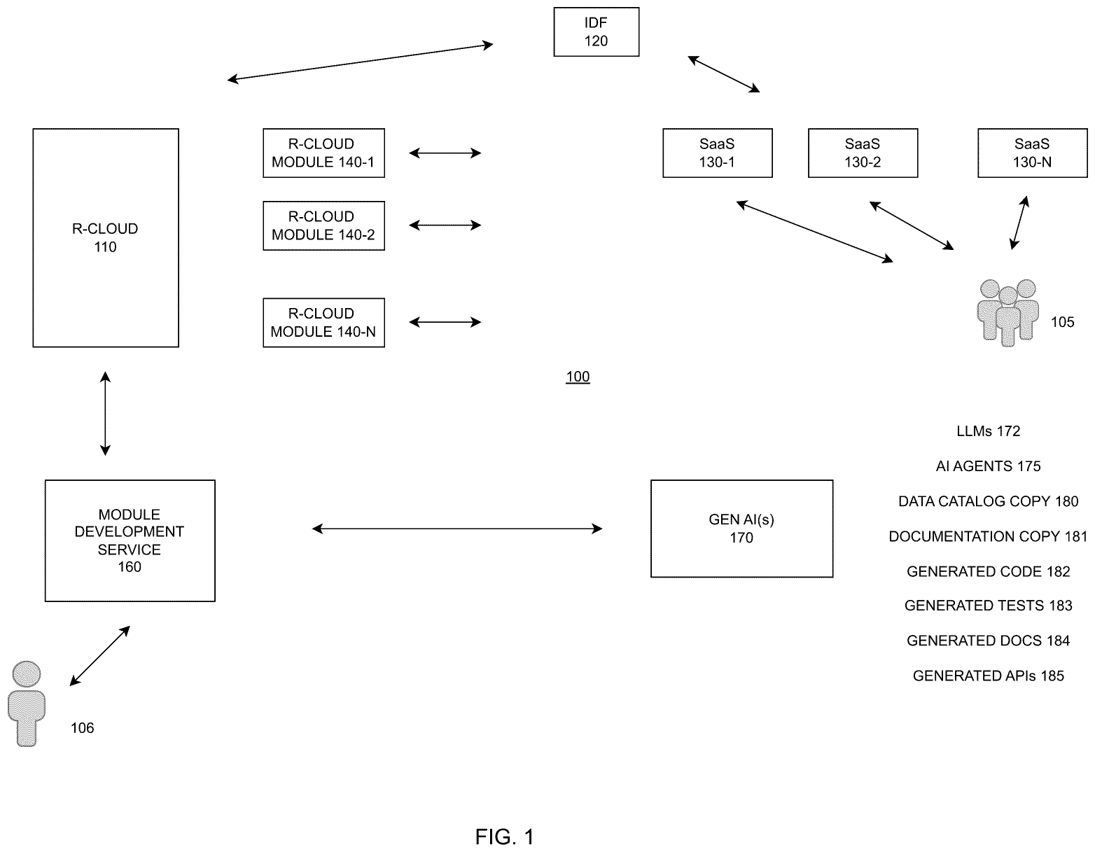

FIG. 1 illustrates a typical data processing environment 100 where a SaaS 130 deploys one or more access points to users 105 via an Application Programming Interface (API). The access points consist of various resources behind which data is organized in some fashion.

The environment 100 may be a typical enterprise such as a business, university, organization, or other group of individual users that access a set of SaaS services and/or applications 130-1, 130-2, . . . , 130-n. In one example, the SaaS′ 130 may include SalesForce, CloudSQL, DropBox and many other SaaS services/applications. It should be understood however that many other types of or additional SaaS services/applications 130 may be deployed.

A modular platform architecture called R-Cloud 110, as described in the above-referenced patent applications, is used here to abstract features of the services 130, such as their core data resilience related management functions. The abstracted features are then managed by a code module called an R-Cloud plug-in or R-Cloud module 140. The approach provides additional functions, such as data resilience, for a new service by creating a new plug-in. The new plug-in can be dynamically added to a running service and the R-Cloud system 110 can then start delivering data resilience.

R-Cloud plug-ins 140-1, 140-2, . . . 140-N are associated with each service 130-1, 130-2, . . . 130-N and each customer instantiation of a service. By way of example, they can record the service's unique authentication methods, sets of attributes, data structures, and data resilience attributes, and other behaviors.

The data processing environment 100 supports automated discovery of SaaS services, applications and data protection and discovery. These features are identified by a developer 106 who is familiar with how to create and deploy R-Cloud modules 140. Methods of probing each SaaS are described in more detail in the referenced patent applications. By way of example. R-Cloud 110 may use an identity provider 120 (such as Okta or AuthO) to gain access the SaaS's 130-1, 130-2, . . . , 130n. R-Cloud 110 in turn to discover attributes of the service that are in use, and an appropriate data protection scheme for each. To provide SaaS awareness, an R-Cloud Module 140-1, 140-2, 140-N is specifically designed for each SaaS service 130-1, 130-2, . . . , 130-N. For example, there is an R-Cloud Module 140-1 for Salesforce, and a different R-Cloud Module 140-2 for Dropbox.

It should be understood that the methods herein can be used to manage different aspects of a SaaS. However, for convenience of the reader, an overview of a data resilience method is provided here. The R-Cloud Platform 110 may first discover the SaaS services 130 that are provisioned and then detect and record details about the data structures in use. This may involve identification of logical data entities used by the SaaS service 130, and respective data and metadata it hosts. To do so, the R-Cloud Platform 110 exposes a set of interfaces that can determine different data types in use by the services 130, and to preferably enforce a common hierarchy and uniformity of SaaS-specific implementations. For example, while there may be an R-Cloud Module 140-1 for a Salesforce data structure and a different R-Cloud Module 140-2 for Dropbox data structure, these data structures have some commonality.

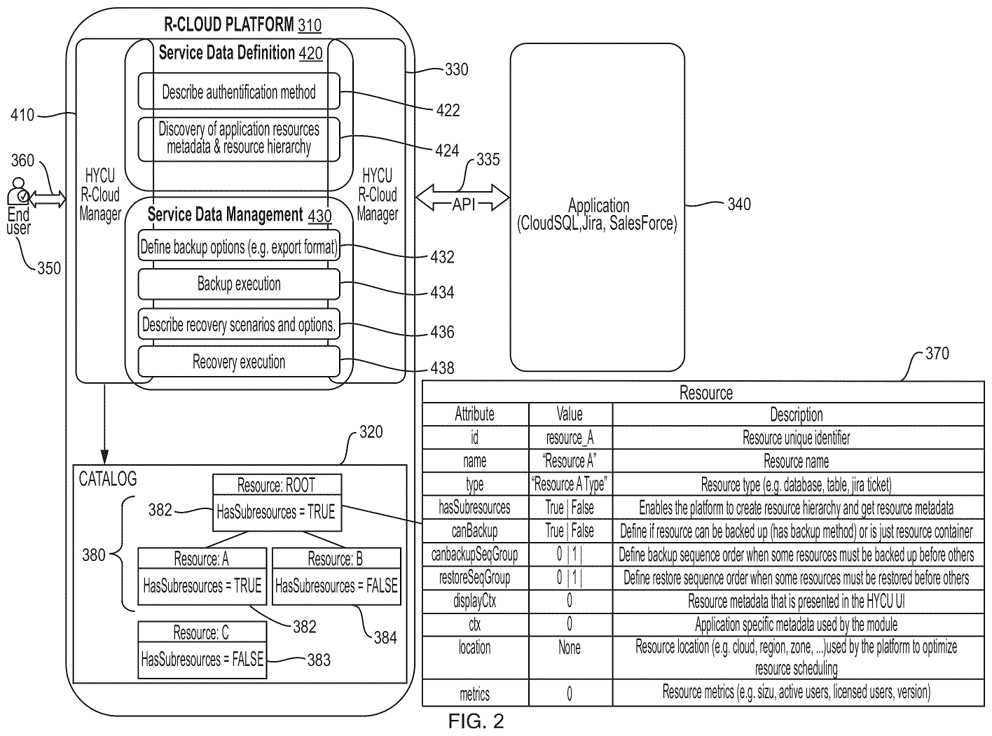

FIG. 2 is a more detailed depiction of the R-Cloud Platform 310, a data catalog 320, and resource 370. In general, discovery of each SaaS is performed to determine if it has a corresponding data protection method and its attributes, such as a backup method, restore method, configuration method, or status method. Other information, such as lists of required attributes and optional attributes is also collected. The specifics of each method and list of attributes differs depending on the type of SaaS application 340.

More particularly, the R-Cloud Platform 310, in some embodiments, includes an R-Cloud Manager 410 component, a Service Data Definition 420, Service Data Management 430, and the R-Cloud Modules 330. Each R-Cloud Module 330 is programmed to access its associated SaaS application 340 such as through an Application Programming Interface (API) 335.

The Service Data Definition 420 consists of methods that include an authentication method 422 and a discovery method 424. These methods are used to discover attributes of a SaaS 340 resource, such as during a LIST operation. Each such operation may return a list that describes certain aspects of the structure of the SaaS application. The structure may identify a list of required attributes that the R-Cloud platform 310 will then use to drive backup and restore methods, as well as an optional list of other attributes.

Service Data Management 430 may include methods for defining backup options 432, backup execution 434, defining recovery services 436 and recovery execution 438.

As shown in FIG. 2, attributes 370 discovered for each SaaS may include values for an identifier, name, and SaaS type. Also discovered may be attributes such as whether or not the SaaS has other related dependent or subservient data objects, provides its own backup method, defines a backup sequence, or defines a restore sequence. Still other attributes may include whether the SaaS can display metadata, its location, and other metrics.

An example of a discovered attribute for a SaaS is a »canBackup« attribute. This indicates to the R-Cloud platform 210 that the SaaS implements a native data backup method. Example optional attributes may further define the »canBackup« attribute to specify, at one or more levels of a data hierarchy, whether backup protection is available. For an example CloudSQL SaaS 340, a «hasSubResources« can be set to True. The child resources may be further defined as optional attributes, such as a list of cloud SQL servers, a list of SQL instances are running on each server, a list of databases running on each SQL instance, and a list of tables in each database. The optional attributes may further specify a »canBackup« attribute for each object in the list, such that it can be determined whether each server, instance, database, and table can or cannot be backed up at its corresponding level.

In the illustrated example of a DropBox SaaS, the catalog indicates that the data objects 380 include a file structure that has a root (top level) folder 382 that hasSubResources. A resource A 382 itself is a folder that hasSubResource C 383. Resource C 383 does not have any child resource. The hasSubResource for object B 384 also indicates that it does not have any child resources.

### Overview of AI-Augmented Authoring

Returning attention to FIG. 1, a Module Development Service (MDS) 160 can leverage one or more generative AI tools 170 to author code for the R-Cloud plug-in modules 140. Generally speaking, this code generation process is both automatic and interactive, with the developer 106 providing a series of plain text prompts to the generative AI 170. These prompts may instruct the generative AI about what the user is looking for, such as a description of the SaaS, how the SaaS works, and the plug-in module's functional requirements. Datasets of existing code for R-Cloud modules 140 that provide similar functionality for other SaaS can also be provided.

The generative AI tool 170 then leverages Large Language Model (LLM) technologies, and/or natural language processing (NLP), deep learning algorithms and or large neural networks trained on user supplier prompts and datasets. The generative AI tool then suggests code snippets or full functions for the new R-Cloud plug-in 140. In some embodiments, the generative AI 170 selected for this purpose can be one that is tailored for code generation. In other implementations, it may be a general purpose LLM 170 such as OpenAI or Anthropic.

Subsequent iterative prompts by the user can further streamline the coding process by handling repetitive tasks and reducing manual coding. Subsequent prompts can also help identify coding errors and potential security vulnerabilities.

The R-cloud module authoring process implemented by the MDS 170 generally operates by enriching one or more Large Language Models (LLMs) 172. The models 172 may include description(s) of the architecture of the R-Cloud platform 110, documentation for typical R-Cloud module development process(es), documentation for R-Cloud module testing processes, R-Cloud APIs, documentation for the SaaS infrastructure information, as well as source code for already exiting R-Cloud modules 140. This documentation and source information can be supplied in any common format utilized by code developers such as Confluence, Jira, Trello, Jenkins, GitHub, etc. files, or emails, text files, indeed, in any forms that can be interpreted by the generative AI 170.

In addition, the MDS 160 can be tested, trained and fine tuned continuously with additional information that reduces the error rates in the modules being developed.

The developer 106 can also provide continuous feedback to the MDS 160 regarding the accuracy of the MDS′ 160 output to get better on a constant basis. Since developing integrations with new as-a-Service offerings require intimate knowledge of the service 130 and also its APIs, the MDS 160 makes it easy for the partner/customer 105 to provide the information about the service to the integrated solution. That information can be automatically maintained as an R-Cloud domain-specific Retrieval-Augmented Generation (RAG) model 172. Thus the process of optimizing the code output by the LLM 170 typically references an authoritative knowledge base (such as maintained in the RAG) outside of its native training sources before generating a response.

The output from the process can include code for the new R-Cloud plug-in modules 140 as well as testing scripts for the modules 140, test procedures for the modules 140 and also preliminary documentation for the modules 140. The MDS can leverage a multi-agent option to create a package including these elements.

The resulting models 172 can also be made available in other code development frameworks like VisualCode and Codeium.

### Leveraging Generative AI 170 to Author R-Cloud Modules 140

To automate authoring of the R-Cloud modules 140 at scale, the MDS 160 also uses agentic systems that can leverage a combination of workflows, specialized agents and classic foundational models, not to mention the development knowledge built into the RAG model 172.

In an example implementation, each module 140 for a given Service 130 encodes five (5) methods:
1) Authentication and Authorization
2) Discovering Application Data Structure, Backup and Recovery capabilities
3) Discovering the application instance(s)
4) Backup Method
5) Recovery Method

To automate the process of creating each of these methods, the MDS 160 leverages a combination of AI workflows, AI agents and an optional step of human validation by the developer 106.

Depending on the service 130 for which the developer 106 is trying to build a module 140, before starting the process at a minimum the developer 106 should obtain access to the following material:

Access to APIs available in the service 130, such as via an OpenAPI specification, a Swagger Specification or another well documented method, or access to an LLM that is already pre-trained on the APIs, like GorillaLLM.

For services 130 that are not well documented or where there not enough public facing documentation, the developer 106 should provide a private document that describes the capabilities of the service.

The MDS 160 preferably leverages a well structured process that is built on popular AI automation frameworks, such as Anthropic's Model Context Protocol (MCP) or LangGraph from LangChain. In addition, the MDS 160 may also leverage a Development AI agent that has been trained on previous R-Cloud model-driven data protection possesses, including those that accommodate the complexities and nuances of data protection, including compliance standards, encryption methodologies, and recovery protocols specific to the R-Cloud's platform architecture.

The Development AI agent 173 is built as follows. Core general purpose large language models, like OpenAI (ChatGPT) or Anthropic are used as a starting point. Those models are then enriched with R-Cloud architecture documentation, R-Cloud module development process documentation, R-Cloud module testing processes, R-Cloud's APIs, the infrastructure environment information, and source code for other R-Cloud modules developed over time for similar functions.

This Information may be retrieved from software development and project management tools such as Jira, Confluence GitHub or other commonly used tools. This information is retained and made available to the module authoring workflow.

### Example Workflow

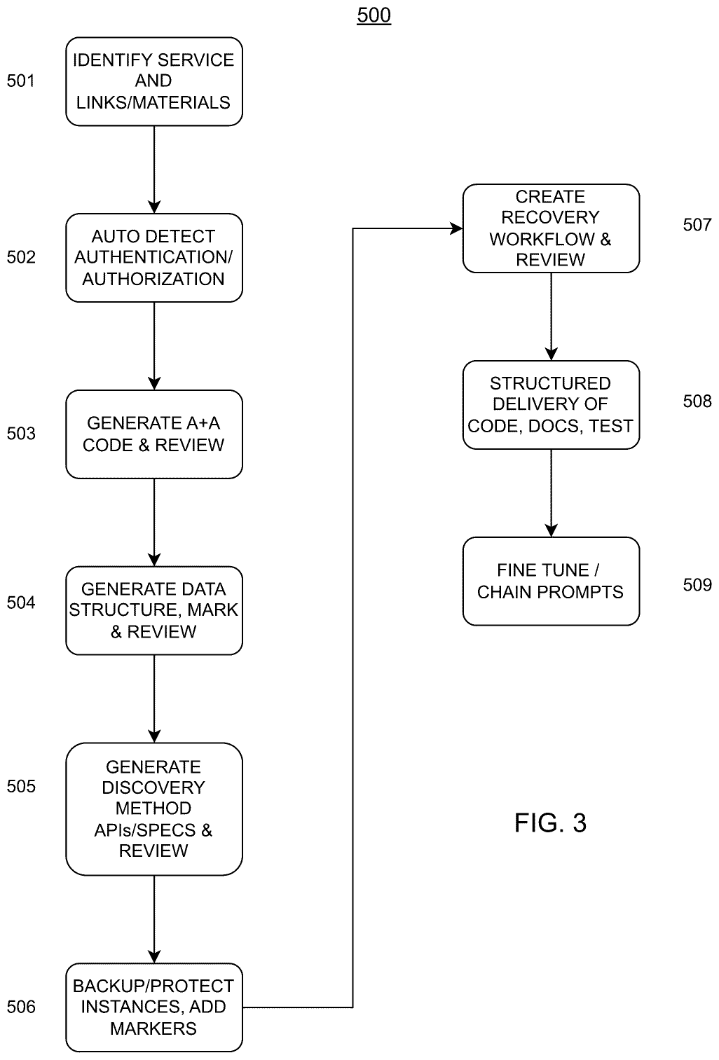

An example workflow 500 for automated generation of an R-Cloud module 140 is shown in FIG. 3.

In step 501, the developer 106 let the R-Cloud Module Development Service (MDS) 160 know for which “as-a-service” 130 they want to develop a data resilience module. This will typically include providing links or actual material that documents those services to the MDS 160.

In step 502, the MDS automatically detects Authentication and Authorization method(s) that will work correctly with R-Cloud 110 from the list of available methods based on the documentation provided in step 401.

In step 503, the MDS 160 presents the developer with the proposed Authentication and Authorization method and the attributes required. If more than one method is viable, it may provide an option to the developer and let them choose one they prefer. The developer will have the ability to edit/update the method or the attributes as presented. Once the update is done, an AI Agent 175 can run through a code review process and present the final output to the developer. The developer will have the ability to edit the method proposed by the MDS 160 as required and update it. This loop process may continue until the developer is satisfied with the output for the authentication method.

In step 504, once the authentication method is established, the MDS 160 leverages the data sources or the LLM 172 provided by developer to determine a complete Application Data Structure 370 (such as was shown in FIG. 2). This can be accomplished using a foundational language model or the LLM 172 provided, and by then identifying and marking which parts of the data structure can be protected and which parts of the service have recovery capabilities. Once the data structure is determined, the data structure can be presented to the developer 106 for conformation. For example, the developer 106 may be given the option of editing the data structure further or can accept it. If the developer 106 provides edits, then the AI Agent 175 can run through a review process and present the final output to the developer 106. The developer 106 has the ability to edit the data structure as required and update it. This loop process may continue till the developer is satisfied with the output.

In step 505, once the data structure is defined, the AI Agent 175 can leverage the data sources provided by the user to create the method needed to discover the services and the associated instance details. In case an LLM 172 was provided, then the LLM 172 is first leveraged to identify the required APIs and their specifications, and that information is passed to the AI agent 175 to continue with the module 140 creation process. Similar to the prior steps, the MDS 160 may go through an iterative process to share the output with the developer 106 and obtain validation, updates or confirmation of the developer's satisfaction with the result.

In step 506, the MDS 160 will leverage the instance information discovered along with the data structure of the service and perform an iterative process of backing up each of the data sources to the depth of the hierarchy as made available by the service. The backup process itself will leverage the API discovered through the data provided by the developer or via the LLM 172 provided by the developer. The MDS 160 may also add a mechanism enable able protecting the data as from a particular timestamp or a particular marker of the service. This marker is stored in the R-Cloud 110 for future reference; code to retrieve the marker data at the start of a backup function may also be added.

In step 507 a development of the recovery process begins. A first step is the actual process to recover the data to the right place and the second part is the preferred presentation and the options allowed to the user based on the capability of the service. Based on the initial data structure definition, a standard recovery process can be created granular recovery and/or full recovery. The MDS 160 may also create the required code to display the list of objects that will be shown for discovery based on the data structure. The developer 106 is given the option to fine-tune the actual presentation and change the defaults presented to the user during recovery process. Similar to the prior steps, the MDS 160 can iterate to share the output with the developer to obtain validation, updates or confirmation of satisfaction.

In step 508, once the module 140 is developed, the MDS 160 can create a structured delivery of all of the required methods and associated files (module code, test methods, documentation, etc.) in a compressed format.

In step 509, for the above steps the prompts may be fine-tuned or chained in such a

fashion to reduce errors and hallucinations.

One of the predominant advantages of this workflow 500 is that methods for additional data collection for new use cases can be easily added. The same framework can be extended with incremental updates to the platform.

The result is a groundbreaking reduction in the time need for development of a module to protect a brand new service-from weeks to hours. It enables SaaS customers 105 to build and deploy new R-Cloud 110 integrations rapidly, while still leveraging the core principles and architecture of the R-Cloud data protection platform. This also ensures that each integration adheres to high standards of security and efficiency.

### Further Implementation Options

It should be understood that the workflow of the example embodiments described above may be implemented in many different ways. In some instances, the various “data processors” may each be implemented by a physical or virtual or cloud-based general purpose computer having a central processor, memory, disk or other mass storage, communication interface(s), input/output (I/O) device(s), and other peripherals. The general-purpose computer is transformed into the processors and executes the processes described above, for example, by loading software instructions into the processor, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system (e.g., one or more central processing units, disks, various memories, input/output ports, network ports, etc.) that enables the transfer of information between the elements. One or more central processor units are attached to the system bus and provide for the execution of computer instructions. Also attached to system bus are typically I/O device interfaces for connecting the disks, memories, and various input and output devices. Network interface(s) allow connections to various other devices attached to a network. One or more memories provide volatile and/or non-volatile storage for computer software instructions and data used to implement an embodiment. Disks or other mass storage provides non-volatile storage for computer software instructions and data used to implement, for example, the various procedures described herein.

Embodiments may therefore typically be implemented in hardware, custom designed semiconductor logic, Application Specific Integrated Circuits (ASICs), Field Programmable Gate Arrays (FPGAs), firmware, software, or any combination thereof.

In certain embodiments, the procedures, devices, and processes described herein are a computer program product, including a computer readable medium (e.g., a removable storage medium such as one or more DVD-ROM's, CD-ROM's, diskettes, tapes, etc.) that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read only memory (ROM); random access memory (RAM); storage including magnetic disk storage media; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

It also should be understood that the block and system diagrams may include more or fewer elements, be arranged differently, or be represented differently. But it further should be understood that certain implementations may dictate the block and network diagrams and the number of block and network diagrams illustrating the execution of the embodiments be implemented in a particular way.

Embodiments may also leverage cloud or other remote data processing services such as Amazon Web Services, Google Cloud Platform, and similar tools. However the services may also be locally hosted.

Accordingly, further embodiments may also be implemented in a variety of computer architectures, physical, virtual, cloud computers, and/or some combination thereof, and thus the computer systems described herein are intended for purposes of illustration only and not as a limitation of the embodiments.

The above description has particularly shown and described example embodiments. However, it will be understood by those skilled in the art that various changes in form and details may be made therein without departing from the legal scope of this patent as encompassed by the appended claims. cm 1. A method for augmenting one or more functions of a SaaS application accessible to a data processing environment, the method comprising:
(a) obtaining information regarding the SaaS application, including at least an identity, an access method and documentation;
(b) prompting one or more generative artificial intelligence (genAI) tools with the information to produce code for authentication and authorization for the SaaS, wherein the one or more genAI tools are based on Large Language Models (LLMs);
(c) augmenting the one or more LLMs with a Retrieval Augmented Generation (RAG) model that represents domain-specific knowledge of the SaaS application and the data processing environment;
(d) prompting the one or more genAI tools to use the LLMs and RAG to produce code for generating a data model for the SaaS and detect at least one resource of the SaaS; and
(e) for one or more instances of the SaaS within the data processing environment, prompting the genAI tool to produce code that initiates the one or more functions for the one or more instances.

2. The method of claim 1 additionally comprising:
enabling a developer to review, modify or approve the code generated in any of steps (b), (c), (d) and/or (e).

3. The method of claim 1 wherein the at least one resource includes a recovery capability of the SaaS.

4. The method of claim 3 wherein the data model for the SaaS includes one or more markers indicating which portions of the data model are recoverable by the SaaS.

5. The method of claim 3 wherein the data model for the SaaS includes one or more markers indicated a time of recovery.

6. The method of claim 1 wherein the one or more functions include data backup.

7. The method of claim 1 where for any of steps (b), (c), (d) and/or (e) the genAI is further prompted to produce documentation or test procedures for the generated code.

8. The method of claim 1 wherein the code generated in any of steps (b), (c) or (d) is provided as a structured code delivery.

9. The method of claim 1 wherein the one or more functions includes automatic data protection for the SaaS, and wherein the data model relates to data objects arranged at one or more levels of a hierarchy within the SaaS, wherein step (e) further comprises generating code for:
discovering data objects accessed by the SaaS;
identifying a service resource for protecting the data object;
discovering attributes specific to the data objects, including a data protection attribute that indicates whether a data protection method is accessible to protect the data objects via the service resource at one or more levels of a hierarchy;
obtaining information for use with an other data protection method that is other than via the service resource;
executing a granular data protection process, by accessing the data protection attribute information for each data object; and
when the data protection attribute is true,
invoking the data protection method accessible via the service resource;
else when the data protection attribute is false,
invoking the other data protection backup method.

10. An apparatus, comprising:
a hardware processor; and
computer memory holding computer program instructions executed by the hardware processor for augmenting one or more functions of a SaaS application accessible to a data processing environment, the computer instructions configured for:
(a) obtaining information regarding the SaaS application, including at least an identity, an access method and documentation;
(b) prompting one or more generative artificial intelligence (genAI) tools with the information to produce code for authentication and authorization for the SaaS, wherein the one or more genAI tools are based on Large Language Models (LLMs);
(c) augmenting the one or more LLMs with a Retrieval Augmented Generation (RAG) model that represents domain-specific knowledge of the SaaS application and the data processing environment;
(d) prompting the one or more genAI tools to use the LLMs and RAG to produce code for generating a data model for the SaaS and detect at least one resource of the SaaS; and
(e) for one or more instances of the SaaS within the data processing environment, prompting the genAI tool to use the one or more LLMs and/or the RAG to produce code that initiates the one or more functions for the one or more instances.

11. The apparatus of claim 10 wherein the instructions are further for:
enabling a developer to review, modify or approve the code generated in any of steps (b), (c), (d) and/or (e).

12. The apparatus of claim 10 wherein the at least one resource includes a recovery capability of the SaaS.

13. The apparatus of claim 12 wherein the data model for the SaaS includes one or more markers indicating which portions of the data model are recoverable by the SaaS.

14. The apparatus of claim 12 wherein the data model for the SaaS includes one or more markers indicated a time of recovery.

15. The apparatus of claim 10 wherein the one or more functions include data backup.

16. The apparatus of claim 10 wherein for any of (b), (c), (d) and/or (e) the genAI is further prompted to produce documentation or test procedures for the generated code.

17. The apparatus of claim 10 wherein the code generated in any of steps (b), (c), (d) or (e) is provided as a structured code delivery.

18. The apparatus of claim 10 wherein the one or more functions includes automatic data protection for the SaaS, and wherein the data model and/or RAG relates to data objects arranged at one or more levels of a hierarchy within the SaaS, and wherein (e) further comprises computer instructions configured to generate code for:
discovering data objects accessed by the SaaS,
identifying a service resource for protecting the data object;
discovering attributes specific to the data objects, including a data protection attribute that indicates whether a data protection method is accessible to protect the data objects via the service resource at one or more levels of a hierarchy;
obtaining information for use with an other data protection method that is other than via the service resource;
executing a granular data protection process, by accessing the data protection attribute information for each data object, and
when the data protection attribute is true,
invoking the data protection method accessible via the service resource;
else when the data protection attribute is false,
invoking the other data protection backup method.
